(19) United States
(12) Patent Application Publication
(10) Pub. No.: US 2015/0014961 A1
(43) Pub. Date: Jan. 15, 2015

(54) VEHICLE PROVIDED WITH A VEHICLE PART

(71) Applicant: SCK MACHINERY, AV Kerkwijk (NL)

(72) Inventor: Pieter Struyk, AV Kerkwijk (NL)

(73) Assignee: SCK MACHINERY, AV Kerkwijk (NL)

(21) Appl. No.: 14/377,043

(22) PCT Filed: Feb. 5, 2013
(86) PCT No.: PCT/NL2013/050059

§ 371 Date: Aug. 6, 2014

(30) Foreign Application Priority Data
Feb. 6, 2012 (NL) 2008237

(51) Int. Cl. B62D 13/02; B60D 1/24; B62D 53/00

(52) U.S. Cl. CPC B62D 13/02; B62D 53/005; B60D 1/24
USPC 280/419

(57) ABSTRACT

The present invention relates to a vehicle (1), comprising a vehicle part (26) comprising:—a connecting frame (20) mountable in substantially rigid manner on the vehicle;—a transport frame connectable to the connecting frame and provided with at least two steerable wheels (32, 34); and—wherein control means are provided which are adapted to counter-steer the steerable wheels of the vehicle part relative to the front wheels (4) of the vehicle, and to adjust the steering angle of the steerable wheels such that an imaginary axis through the rotation shaft of the steerable wheels of the vehicle part intersects at the intersection an imaginary axis through the left front wheel of the vehicle, an imaginary axis through the right front wheel of the vehicle and an imaginary axis through the rear wheels of the vehicle.

The invention relates to a vehicle with a vehicle part, in particular with a vehicle part providing an existing vehicle with a new and/or improved range of applications.

Small terrain utility vehicles such as the RTV series developed by the Kubota company are much utilized in the green sector and by (semi-)public services. Such vehicles are characterized as agricultural vehicle and are utilized for instance for clearing ice and snow from cycle paths. Another application is in the sport of golf, where such vehicles are employed as ball collector on the driving range, but also to perform maintenance operations on the golf course, such as spraying thereof using means.

It is desirable to increase the transport capacity of such a vehicle so that for instance during snow and ice clearance the greatest possible amount of de-icing salt can be carried in a responsible manner.

In addition, a high degree of manoeuvrability of the vehicle is desirable.

An object of the present invention is to provide a vehicle with vehicle part with which it is possible to provide an existing vehicle with a new and/or improved range of applications.

Said object is achieved with the vehicle according to claim 1.

Because the vehicle part is provided with wheels, a vehicle provided therewith acquires an additional contact surface with the ground. The transport frame of the vehicle part hereby gives the vehicle additional load-bearing capacity while the axle load remains the same, or provides the same load-bearing capacity at a lower axle load.

The vehicle part cannot rotate about a standing rotation axis oriented in height direction of the vehicle part, whereby the vehicle part lies at all times in line with the vehicle. Pivoting in the lying plane, as is possible with a conventional fifth wheel between a tractor and a trailer, is prevented. An advantage hereof is that the vehicle and vehicle part form one whole in longitudinal direction, and jackknifing during reversing—to which for instance a short tractor-trailer combination is particularly susceptible—is hereby prevented.

Because the wheels of the vehicle part are steerable, the vehicle part provides an existing vehicle with an additional range of applications while the manoeuvrability of the vehicle with vehicle part is retained.

The connection between the connecting frame and the transport frame is such that only a rotation about a transverse rotation axis oriented in transverse direction of the vehicle part is allowed, whereby unevenness in the ground surface can be negotiated without problem by a vehicle with vehicle part. The driven wheels, when travelling over a speed bump or when travelling up or down a slope, are in this way prevented from moving clear of the ground surface such that insufficient traction remains.

The vehicle with vehicle part further comprises control means adapted to counter-steer the steerable wheels of the vehicle part relative to the front wheels of the vehicle. A high degree of manoeuvrability of the combination of vehicle-vehicle part is obtained by counter-steering the steerable wheels of the vehicle part relative to the steering position of the front wheels of the vehicle.

The control means are adapted to adjust the steering angle of the steerable wheels such that an imaginary axis through the rotation shaft of the steerable wheels of the vehicle part intersects at the intersection an imaginary axis through the left front wheel of the vehicle, an imaginary axis through the right front wheel of the vehicle and an imaginary axis through the rear wheels of the vehicle. All wheels of the combination of vehicle-vehicle part will hereby follow a path during a steering action such that they roll truly and side-slip is prevented. The absence of side-slip on the one hand reduces tyre wear and mechanical load on the wheels and wheel suspension. When manoeuvring over a vulnerable ground surface such as a golf course, the vehicle will on the other hand exert minimal load on the ground surface.

According to a preferred embodiment, the connecting frame comprises at least two rotation points through which the transverse rotation axis runs. This transverse rotation axis can be a physical shaft, but can expressly also be a purely mathematical axis through the rotation points. When the transport frame is mounted in rotatable manner on the rotation points of the connecting frame, this ensures that a rotation is allowed about a transverse rotation axis oriented in transverse direction of the vehicle part. The vehicle with vehicle part is hereby also suitable for ground surfaces which are not completely flat, as elucidated above.

According to a further preferred embodiment, the steerable wheels are mounted rotatably on the transport frame using a slewing ring. Although the invention does not preclude an alternative steering, such as for instance with stub axles, the use of a slewing ring is recommended. The distance between the wheels following the outer bend increases temporarily in the case of a slewing ring, whereby the risk of the combination of the vehicle and the vehicle part overturning is considerably reduced. A slewing ring also enables a simple construction.

According to yet another preferred embodiment, the rotation axis of the steerable wheels is arranged a distance to the rear relative to the rotation centre of the slewing ring. Owing to this castor effect the assembly of the slewing ring and the wheels of the vehicle part behave as a swivel wheel, similarly to a shopping trolley. The favourable effect hereof is that the steerable wheels take up a stable position of equilibrium in autonomous manner. Unstable behaviour of the wheels of the vehicle part is hereby prevented.

According to yet another and alternative embodiment, the steerable wheels are mounted with a stub axle construction on the vehicle part. A stub axle construction requires less steering effort for adjusting the steering position of the wheels of the vehicle part in (substantially) stationary position. An embodiment with stub axle construction is hereby particularly advantageous when the vehicle also has to be employed on heavy terrain.

A further advantage of a stub axle construction is that a less heavy form of power steering will suffice. It is hereby possible for instance to provide a commercially available terrain utility vehicle, such as the RTV series developed by the Kubota company, with a vehicle part according to the invention and to also use the standard power steering already available to steer the wheels of the vehicle part.

According to yet another preferred embodiment, a hydraulic steering cylinder is provided which is adapted to adjust the steering position of the wheels of the vehicle part by means of realizing a rotation of the slewing ring relative to the transport frame.

According to a further preferred embodiment of the vehicle, a vehicle part is applied having a hydraulic steering cylinder which is adapted to adjust the steering position of the wheels of the vehicle part by means of realizing a rotation of the slewing ring relative to the transport frame, wherein:
the vehicle comprises a hydraulic steering cylinder; and
the hydraulic steering cylinder of the vehicle part has substantially the same stroke volume as the hydraulic steering cylinder of the vehicle.

The vehicle from the Kubota RTV series referred to in the introduction makes use of hydraulic control. By also providing the vehicle part with a hydraulic steering cylinder the steerable wheels of the vehicle part and those of the tractive vehicle can be coupled with minimum intervention. Major modifications to the tractive vehicle are unnecessary.

According to yet another preferred embodiment of the vehicle, the hydraulic steering cylinder of the vehicle and the hydraulic steering cylinder of the vehicle part are in direct liquid connection.

Preferred embodiments of the present invention are further elucidated in the following description with reference to the drawing, in which:

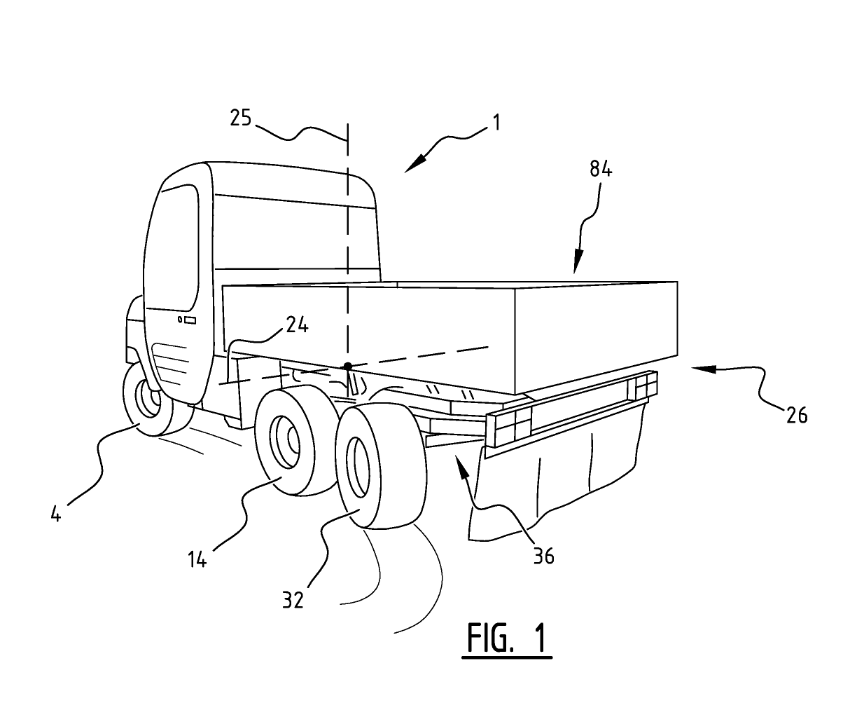

FIG. 1 is a perspective view of a vehicle with a vehicle part according to the invention;

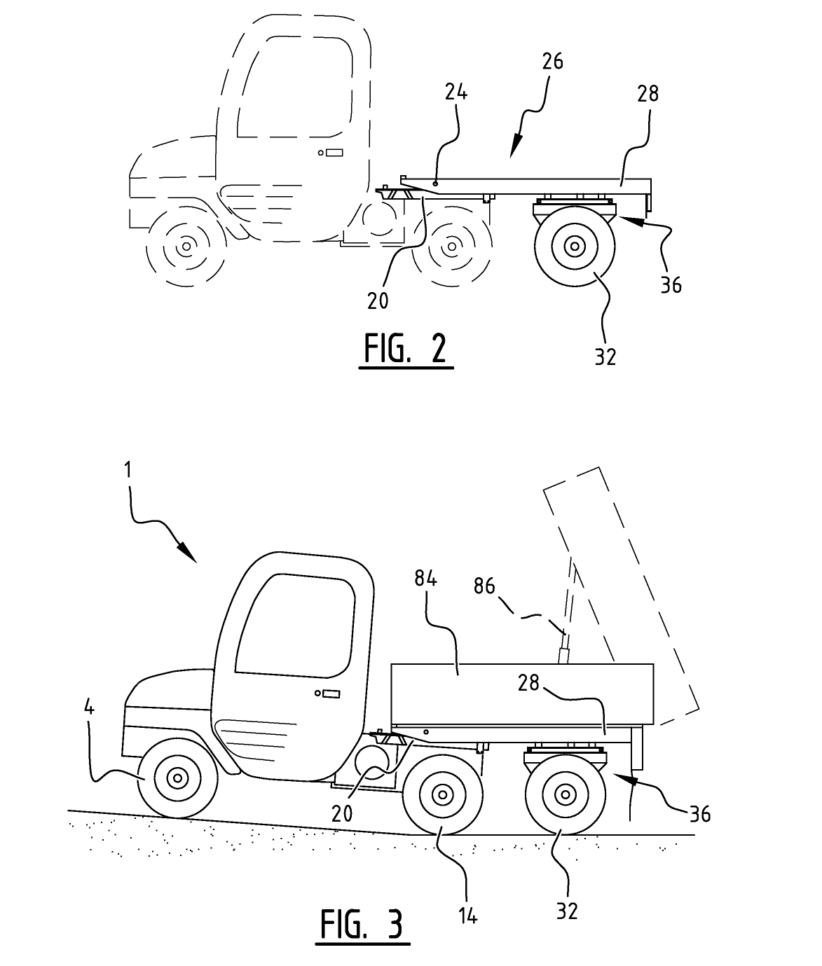

FIG. 2 is a side view of the vehicle shown in FIG. 1 in a first preferred embodiment, and on a flat ground surface;

FIG. 3 is a side view of the vehicle shown in FIG. 1 in a second preferred embodiment, and on an uneven ground surface;

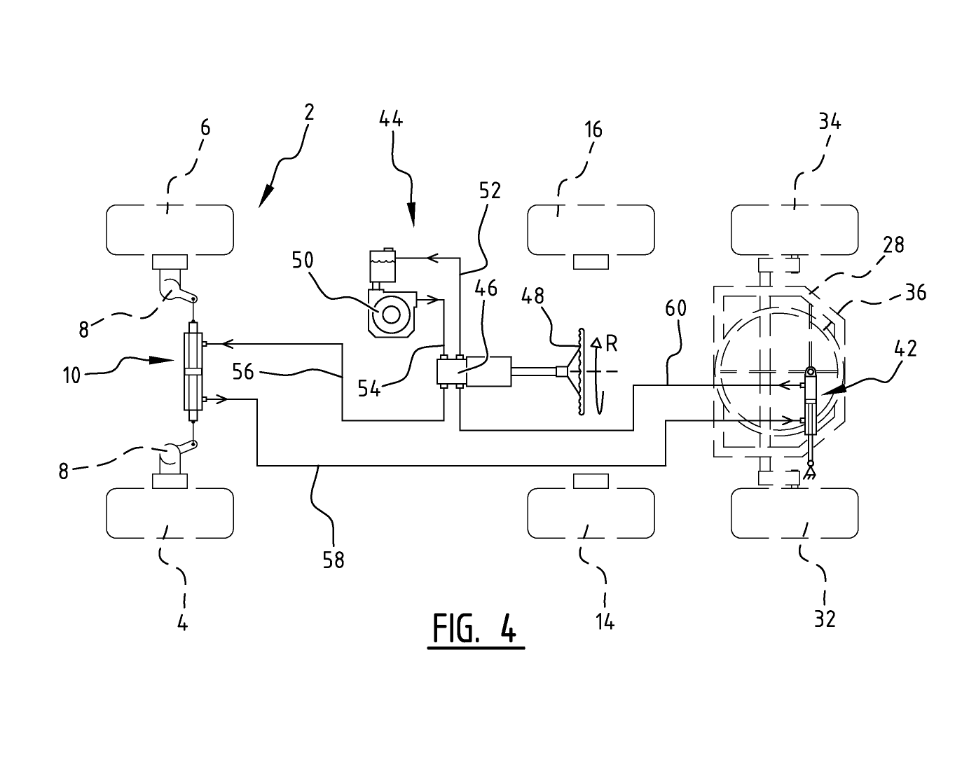

FIG. 4 is a schematic top view of the hydraulic system of the vehicle shown in FIG. 1;

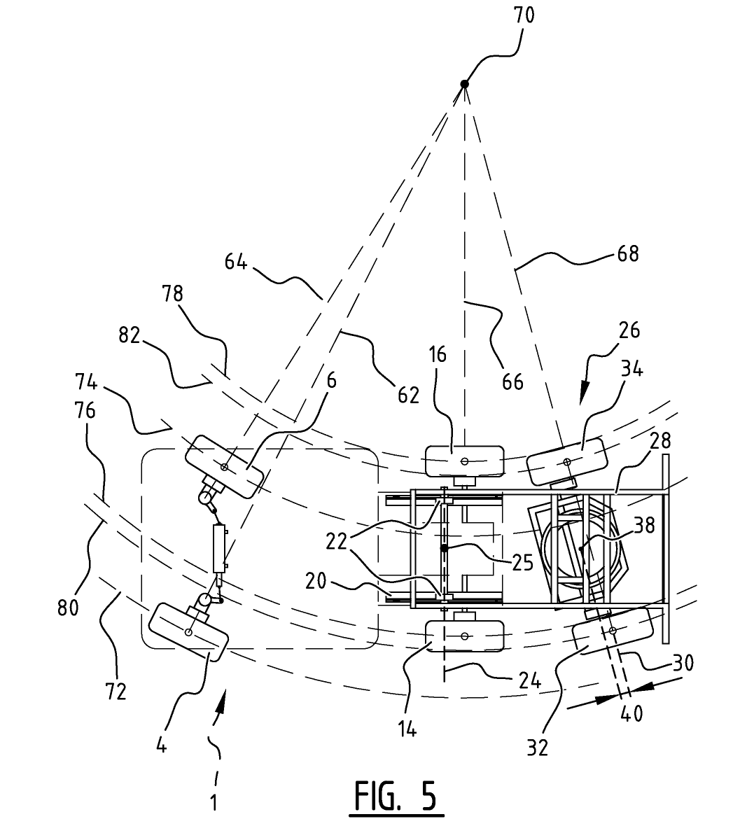

FIG. 5 is a schematic top view of the vehicle shown in FIG. 1 with a steering position ensuing from the input into the hydraulic system shown in FIG. 4;

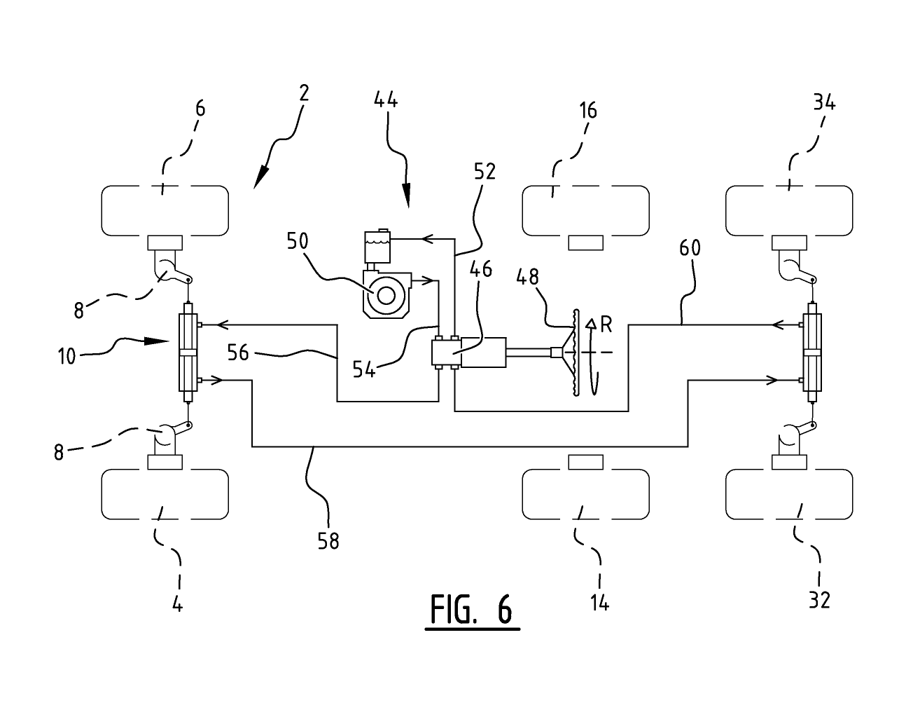

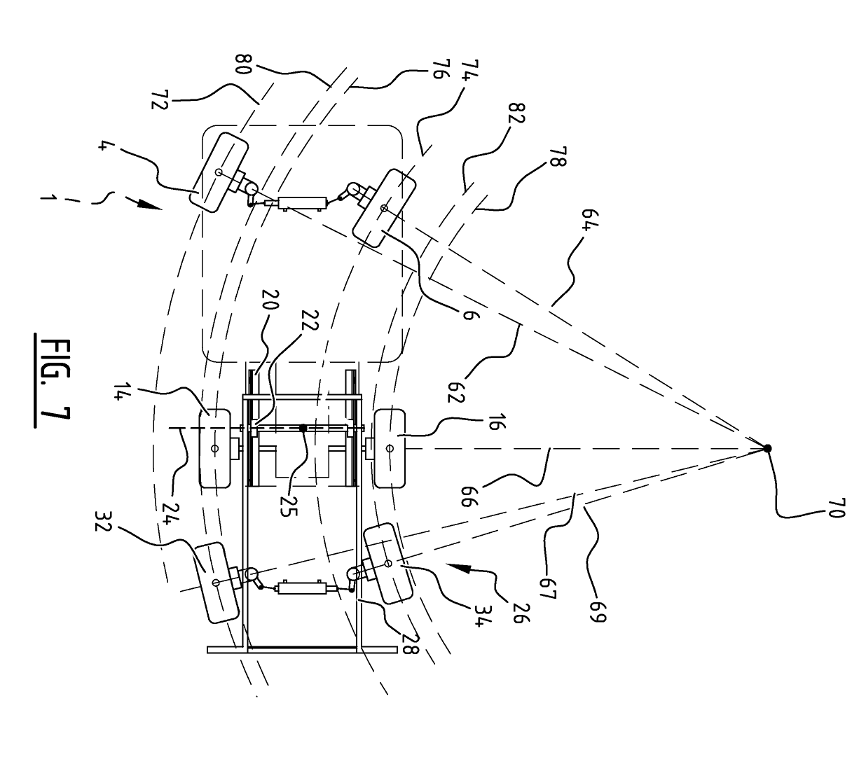

FIG. 6 is a schematic top view of the hydraulic system of an alternative embodiment of a vehicle according to the invention; and

FIG. 7 is a schematic top view of a vehicle with a steering position ensuing from the input into the hydraulic system shown in FIG. 6.

Shown in FIG. 1 is a vehicle 1 with six wheels, of which the left-hand wheels 4, 14, 32 are shown. Vehicle 1 is taking a bend to the left, wherein the left-hand front wheel 4 of vehicle 1 is steered into the bend and the rear left-hand wheel 32 is counter-steered. The left front wheel 4 and the left wheel 14 are both part of vehicle 1, while the rear left wheel 32 is arranged on a vehicle part 26. This vehicle part 26, which can carry for instance a tipping body 84, a salt-spreader (not shown) or other part, is coupled to vehicle 1.

Vehicle part 26 is coupled to vehicle 1 for pivoting about a transverse rotation axis 24 functioning as pivot axis, while pivoting around a standing rotation axis 25 is prevented in structural manner.

The steerable wheels 32, 34 of vehicle part 26 are mounted with a slewing ring 36 on transport frame 28 of vehicle part 16 (FIG. 2).

While a vehicle 1 itself has a typical load-bearing capacity of about 2000 kg, the combination of vehicle 1 with vehicle part 26 can be loaded up to about 3000 kg. This load-bearing capacity is distributed over six wheels, and because the steerable wheels 32, 34 of vehicle part 26 counter-steer with front wheels 4, 6 of vehicle 1, a turning circle with a radius of 7.5 metres can be realized at a vehicle length of the combination of vehicle 1 and vehicle part 26 of four metres.

Because vehicle part 26 is provided with steerable wheels 32, 34, a vehicle 1 provided therewith acquires an additional contact surface with the ground. Transport frame 28 of vehicle part 26 hereby gives vehicle 1 additional load-bearing capacity while the axle load remains the same, or provides the same load-bearing capacity at a lower axle load.

The tractive vehicle 1 is provided with a connecting frame 20 which is secured for instance using straps to the original frame of vehicle 1.

Because vehicle part 26 is coupled for pivoting about a transverse rotation axis 24 functioning as pivot axis, it is guaranteed that rear wheels 14, 16 of the vehicle will maintain contact with the ground surface at all times, as illustrated in FIG. 3 when travelling up a slight slope. In the case of a vehicle 1 with two-wheel drive, the rear wheels 14, 16 thereof will generally be driven, whereby it is desirable that they maintain contact with the ground.

Because the slewing ring 36 is arranged under transport frame 28 of vehicle part 26, sufficient space is provided to enable tilting of tipping body 84 into a high position using a tipping cylinder 86 (FIG. 3).

The high degree of manoeuvrability of the combination of vehicle 1 and vehicle part 26 will be elucidated with reference to FIGS. 4 and 5, wherein the steering input R given to steering wheel 48 in FIG. 4 results in the wheel positions steered into the bend as shown in FIG. 5.

When steering wheel 48 undergoes an angular displacement R, oil begins to flow via the distributing means (or orbitrol) 46, via the first hydraulic conduit 52 and pump 53 and the second hydraulic conduit 54 via the third hydraulic conduit 56 to the steering cylinder 10 of front wheels 4, 6. This front wheel steering cylinder 10 is adapted to position front wheels 4, 6 via stub axles 8 in the desired steering position (in this case to the right) on the basis of the angular displacement R of steering wheel 48 (FIG. 5). Guiding the oil which has flowed from distributing means 46 to the front wheel steering cylinder 10 via the fourth hydraulic conduit 58 to steering cylinder 42 of vehicle part 26 achieves that wheels 32, 34 of vehicle part 26 take up a desired counter-steered position via steering cylinder 42 and slewing ring 36.

In order to allow optimum co-action between the front wheel steering cylinder 10 and steering cylinder 42 of vehicle part 26, they preferably have the same stroke volume.

The oil which has flowed via the fourth hydraulic conduit 58 into steering cylinder 42 of vehicle part 26 then flows back via a fifth hydraulic conduit 60 to distributing means 46.

The top view of FIG. 5 shows the final steering position which ensues from the angular displacement R shown in FIG. 4.

In FIG. 5 the steering angle of the steerable front wheels 4, 6 of vehicle 1 is such that the imaginary axes 62, 64 intersect at an intersection 70. Running through rear wheels 14, 16 of vehicle 1 is an imaginary axis 66 which also intersects at intersection 70. This interplay between front wheels 4, 6 and rear wheels 14, 16 of vehicle 1 is essentially how the tractive vehicle 1 would itself steer, i.e. without vehicle part 26. The intersection 70 forms here the rotation point round which vehicle 1 turns.

Vehicle part 26 is arranged for pivoting about pivot axis 24 through the pivot points 22 of connecting frame 20 and has on the underside of transport frame 28 a slewing ring 36 on which the wheels 32, 34 of vehicle part 26 are arranged. The left wheel 32 and the right wheel 34 are situated a distance 40 behind the centre 38 of slewing ring 36, whereby a swivel wheel effect results.

The steering position of wheels 32, 34 of vehicle part 26 are chosen such that the imaginary axis 68 through the two wheels 32, 34 likewise intersects at intersection 70. As a result all wheels 4, 6, 14, 16, 32, 34 follow a curve around rotation point 70, thereby preventing one or more of the wheels of the combination of vehicle 1 and vehicle part 26 undergoing side-slip.

The left front wheel 4 of vehicle 1 displaces here through a curve 72, the right front wheel 6 of vehicle 1 displaces here through a curve 74, the left rear wheel 14 of vehicle 1 displaces here through a curve 76, the right rear wheel 16 of vehicle 1 displaces here through a curve 78 and the steerable wheels 32, 34 of vehicle part 26 displace here through respective curves 80, 82.

In the embodiment wherein vehicle part 26 is provided with a slewing ring 36 the wheels which follow the outer bend, i.e. wheels 4, 14 and 32 in FIG. 5, will displace away from each other, whereby the stability of the combination of vehicle-vehicle part increases and the risk of overturning while taking a bend at high speed is reduced.

In contrast to the embodiment shown in FIGS. 4 and 5, in the alternative embodiment of the vehicle shown in FIGS. 6 and 7 the wheels 32, 34 are mounted with a stub axle construction on vehicle part 26.

The use of a stub axle construction for wheels 32, 34 of vehicle part 26 has the advantage that in stationary position the wheels 32, 34 are adjustable to a different steering position with much less effort. This is because in the case of stub axle steering the wheels 32, 34 rotate substantially on the spot, wherein friction need only be overcome between the support surface of the wheels and the ground surface. In the embodiment with a slewing ring—as shown in FIGS. 4 and 5—the whole slewing ring 36 would rotate and wheels 32, 34 would also roll when being moved to a different steering position.

The lesser steering effort required when a stub axle construction is applied is particularly advantageous when the wheels have to be adjusted on heavy terrain in (substantially) stationary position. In addition, a less heavy form of power steering will suffice when a stub axle construction is applied, whereby it is for instance possible to provide a commercially available terrain utility vehicle, such as the RTV series developed by the Kubota company, with a vehicle part 26 according to the invention and to also use the standard power steering already available to steer the wheels 32, 34 of vehicle part 26.

The alternative embodiment shown in FIG. 6 differs from the embodiment shown in FIG. 4 only in the stub axle construction for steering the wheels 32, 34 of vehicle part 26.

Shown in the top view of FIG. 7 is the final steering position which ensues from the angular displacement R shown in FIG. 6.

In FIG. 7 the steering angle of the steerable front wheels 4, 6 of vehicle 1 is such that the imaginary axes 64, 62 intersect at an intersection 70. Running through rear wheels 14, 16 of vehicle 1 is an imaginary axis 66 which also intersects at intersection 70. As already elucidated with reference to FIG. 5, this interplay of front wheels 4, 6 and rear wheels 14, 16 of vehicle 1 is how the tractive vehicle 1 would itself steer, i.e. without vehicle part 26. The intersection 70 forms here the rotation point round which vehicle 1 turns.

Vehicle part 26 is once again arranged for pivoting about the pivot axis 24 through the pivot points 22 of connecting frame 20.

The steering position of wheels 32, 34 of vehicle part 26 is adjusted with the stub axle construction such that the imaginary axes 67, 69 of the respective wheels 32, 34 likewise intersect at intersection 70. As a result all wheels 4, 6, 14, 16, 32, 34 follow a curve around rotation point 70, thereby preventing one or more of the wheels of the combination of vehicle 1 and vehicle part 26 undergoing side-slip.

The left front wheel 4 of vehicle 1 displaces here through a curve 72, the right front wheel 6 of vehicle 1 displaces here through a curve 74, the left rear wheel 14 of vehicle 1 displaces here through a curve 76, the right rear wheel 16 of vehicle 1 displaces here through a curve 78 and the steerable wheels 32, 34 of vehicle part 26 displace here through respective curves 80, 82.

Although they show preferred embodiments of the invention, the above described embodiments are intended solely to illustrate the present invention and not in any way to limit the specification of the invention. The rights described are defined by the following claims, within the scope of which many modifications can be envisaged.

1. A vehicle comprising:
a vehicle part, the vehicle part comprising:
a connecting frame mountable in substantially rigid manner on a vehicle;
a transport frame connectable to the connecting frame and provided with at least two steerable wheels; and
wherein the connection between the connecting frame and the transport frame is such that only a rotation about a transverse rotation axis oriented in transverse direction of the vehicle part is allowed, while rotation about a standing rotation axis oriented in height direction of the vehicle part is prevented;
characterized in that control means are provided which are adapted to counter-steer the steerable wheels of the vehicle part relative to the front wheels of the vehicle, and to adjust the steering angle of the steerable wheels such that an imaginary axis through the rotation shaft of the steerable wheels of the vehicle part intersects at the intersection an imaginary axis through the left front wheel of the vehicle, an imaginary axis through the right front wheel of the vehicle and an imaginary axis through the rear wheels of the vehicle.

2. The vehicle of claim 1, wherein the connecting frame comprises at least two rotation points through which the transverse rotation axis runs.

3. The vehicle of claim 1, wherein the steerable wheels of the vehicle part are mounted rotatably on the transport frame using a slewing ring.

4. The vehicle of claim 3, wherein the rotation axis of the steerable wheels of the vehicle part is arranged a distance to the rear relative to the rotation centre of the slewing ring.

5. The vehicle of claim 1, wherein a hydraulic steering cylinder is provided which is adapted to adjust the steering position of the wheels of the vehicle part by means of realizing a rotation of the slewing ring relative to the transport frame.

6. The vehicle of claim 1, wherein the steerable wheels are mounted with a stub axle construction on the vehicle part.

7. The vehicle of claim 5, wherein:
the vehicle comprises a hydraulic steering cylinder; and
the hydraulic steering cylinder of the vehicle part has substantially the same stroke volume as the hydraulic steering cylinder of the vehicle.

8. The vehicle of claim 7, wherein the hydraulic steering cylinder of the vehicle and the hydraulic steering cylinder of the vehicle part are in direct liquid connection.

9. The vehicle of claim 2, wherein the steerable wheels of the vehicle part are mounted rotatably on the transport frame using a slewing ring.

10. The vehicle of claim 2, wherein a hydraulic steering cylinder is provided which is adapted to adjust the steering position of the wheels of the vehicle part by means of realizing a rotation of the slewing ring relative to the transport frame.

11. The vehicle of claim 3, wherein a hydraulic steering cylinder is provided which is adapted to adjust the steering position of the wheels of the vehicle part by means of realizing a rotation of the slewing ring relative to the transport frame.

12. The vehicle of claim 4, wherein a hydraulic steering cylinder is provided which is adapted to adjust the steering position of the wheels of the vehicle part by means of realizing a rotation of the slewing ring relative to the transport frame.

13. The vehicle of claim 2, wherein the steerable wheels are mounted with a stub axle construction on the vehicle part.

14. The vehicle of claim 6, wherein:
the vehicle comprises a hydraulic steering cylinder; and
the hydraulic steering cylinder of the vehicle part has substantially the same stroke volume as the hydraulic steering cylinder of the vehicle.
